(19) United States
(12) Patent Application Publication
(10) Pub. No.: US 2026/0107138 A1
(43) Pub. Date: Apr. 16, 2026

(54) SECURITY FOR MOBILE DATA RELAY DEVICES IN A COMMUNICATION NETWORK

(71) Applicant: AT&T Intellectual Property I, L.P., Atlanta, GA (US)

(72) Inventors: Joseph Soryal, Glendale, NY (US); Venson Shaw, Kirkland, WA (US); Jason V. Chang, Decatur, GA (US)

(21) Appl. No.: 18/917,878

(22) Filed: Oct. 16, 2024

(51) Int. Cl. H04W 12/06; H04W 12/04; H04W 12/63; H04W 84/06

(52) U.S. Cl. CPC H04W 12/06; H04W 12/04; H04W 12/63; H04W 84/06

(57) ABSTRACT

A processor of a network device may receive an authentication request from a first authentication application installed on a mobile data relay device, wherein the authentication request includes a key, may determine that the mobile data relay device is in a predicted location calculated by a second authentication application installed on the network device, may determine that the key is a valid key that was distributed by a first authentication server, and may establish a communication channel with the mobile data relay device when the mobile data relay device is authenticated based on the key being determined to be the valid key and a current location of the mobile data relay device being in the predicted location.

The present disclosure relates generally to cellular networks, and more particularly to methods, non-transitory computer-readable media, and apparatuses for providing improved security for mobile data relay devices in a communication network.

### BACKGROUND

Current trends in wireless technology are leading towards a future where virtually any object can be network-enabled and addressable on-network. The pervasive presence of cellular and non-cellular wireless networks, including fixed, ad-hoc, and/or or peer-to-peer wireless networks, satellite networks, and the like along with the migration to a 128-bit IPv6-based address space provides the tools and resources for the paradigm of the Internet of Things (IoT) to become a reality. To expand the range of the wireless networks and to support the increased bandwidth requirements, mobile data relay devices may be used to carry wireless signals in regions that lack a base station or radio on the ground.

### SUMMARY

In one example, the present disclosure discloses a method, computer-readable medium, and apparatus for detecting a mobile data relay device that is a security threat. For example, a processor of a network device may receive an authentication request from a first authentication application installed on a mobile data relay device, wherein the authentication request includes a key, determine that the mobile data relay device is in a predicted location calculated by a second authentication application installed on the network device, determine that the key is a valid key that was distributed by a first authentication server and establish a communication channel with the mobile data relay device when the mobile data relay device is authenticated based on the key being determined to be the valid key and a current location of the mobile data relay device being in the predicted location.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates an block diagram of that illustrates an example detection of a mobile data relay device that is a security threat, in accordance with the present disclosure;

FIG. 3 illustrates a flowchart of an example method for detecting a mobile data relay device that is a security threat, in accordance with the present disclosure; and

FIG. 4 illustrates a high level block diagram of a computing device specifically programmed to perform the steps, functions, blocks and/or operations described herein.

To facilitate understanding, similar reference numerals have been used, where possible, to designate elements that are common to the figures.

### DETAILED DESCRIPTION

The present disclosure broadly discloses methods, non-transitory computer-readable media, and apparatuses for detecting a mobile data relay device that is a security threat. As noted above, mobile data relay devices may be used to carry signals across a communications network in areas where it may be difficult to build a base station or radio on the ground. Hundreds of mobile data relay devices, such as a satellite or unmanned aerial vehicle (UAV), may be deployed in the air or around Earth's orbit.

However, sometimes, these mobile data relay devices may be hacked. As a result, data that is transmitted across these mobile data relay devices may be compromised.

In accordance with the present disclosure, an improved authentication method may be deployed to prevent hacking and to improve detection of rogue mobile data relay devices that may be a security threat to a communication network. The improved authentication method may use a new unique authentication application, also referred to as a dynamic distributed authenticator application (DDAA). The DDAA software may be generated as part of an overall mathematical model or set of equations. In other words, each DDAA may be a unique part or segment of the overall mathematical model. As a result, when new satellites or cell sites are deployed, each DDAA may be deleted and new DDAAs may be generated from a new overall mathematical model. The new DDAAs can then be assigned to each of the satellites and cell sites, including any new satellites.

The DDAA may be used to track the location of the mobile data relay devices and provide keys for authentication. Information about the mobile data relay devices may be stored as part of a distributed ledger that is shared with the DDAAs installed on other cell sites or authentication servers. The information may include interaction data with the mobile data relay device and location data. The location data may include a current location of the mobile data relay device, an estimated speed of the mobile data relay device, a direction or heading of movement of the mobile data relay device, a path of the mobile data relay device, e.g., a particular orbit around Earth, and the like. The location data can then be provided to another cell site or authenticator server to which the mobile data relay device is being handed off to. The next authentication server or network device with the DDAA may then use the location data to predict a location of the mobile data relay device by generating a map to visualize where the mobile data relay device should be located. The predicted location may be used as part of the authentication process of the mobile data relay device.

In one embodiment, the DDAA may also store a register of keys. The keys may be shared amongst all of the authenticator servers. Then each authenticator server may assign the same key to a particular mobile data relay device for authentication. The key may be a one-time use key. Thus, when the mobile data relay device comes within range of an authentication server to connect to the communication network, the key may be presented to the authentication server as another part of the authentication process of the mobile data relay device.

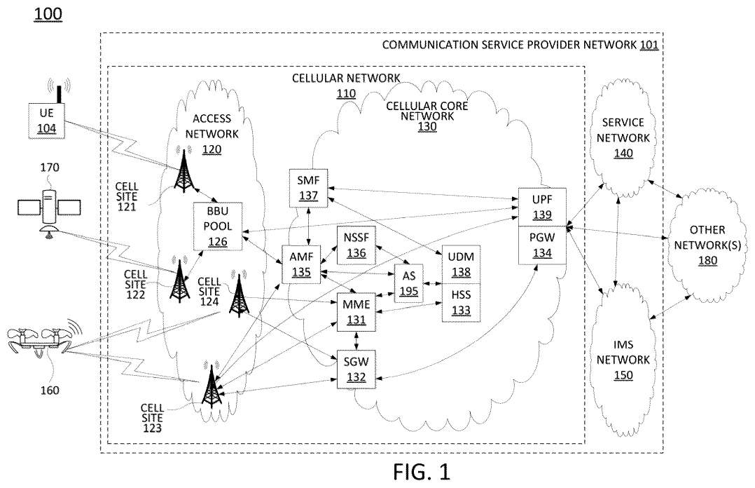

Lastly, the mobile data relay device may be deployed as a passive transporter. In other words, the mobile data relay device may be configured such that the mobile data relay device simply forwards data without reading the contents of the data. For example, any data packet transmitted to the mobile data relay device after authentication may be encrypted and include a destination address of a next node. The mobile data relay device may only be able to read the destination address of the next node. As a result, the mobile data relay device simply forwards the data packet to the destination address of the next node without reading the contents of the data packet. These and other aspects of the present disclosure are described in greater detail below in connection with the examples of FIGS. 1-4.

FIG. 1 illustrates an example network, or system 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

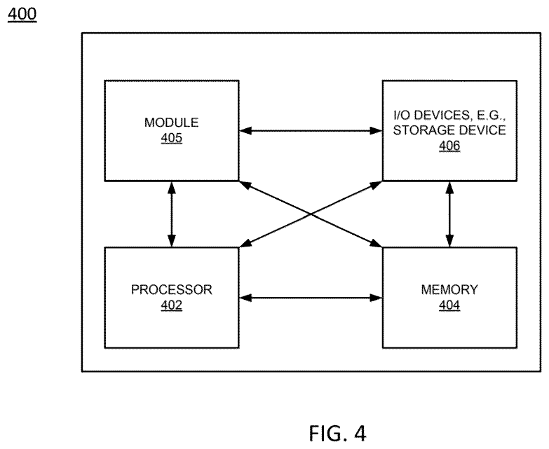

In accordance with the present disclosure, any one or more of cell sites 121-123 may be deployed with antenna and radio infrastructures, including multiple input multiple output (MIMO) and millimeter wave antennas. Furthermore, in accordance with the present disclosure, a base station (e.g., cell sites 121-123 and/or baseband units within BBU pool 126) may comprise all or a portion of a computing system, such as computing system 400 as depicted in FIG. 4, and may be configured to perform steps, functions, and/or operations in connection with examples of the present disclosure for detecting a mobile data relay device that is a security threat.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth. In accordance with the present disclosure, a network slice may be dedicated to UAV type UEs as described herein.

In one example, SMF 137 may perform endpoint device IP address management, UPF selection, UPF configuration for endpoint device traffic routing to an external packet data network (PDN), charging data collection, quality of service (QoS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104. UE 104 may comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). As illustrated in FIG. 1, UE 104 may access wireless services via the cell site 121 (e.g., NR alone, where cell site 121 comprises a gNB)

It should be noted that examples of the present disclosure as described herein primarily in connection with steps, functions, and/or operations are performed by a processing system in cellular core network 130, such as application server (AS) 195, AMF 135, SMF 137, MME 131, or the like. In an example, the AS 195 may also be referred to as an authentication server (AS) 195. Although a single AS 195 is illustrated in FIG. 1, it should be noted that the AS 195 may be distributed across the communication server provider network 101 at different geographic locations. The AS 195 may comprise all or a portion of a computing system, such as computing system 400 depicted in FIG. 4, and may be configured to perform steps, functions, and/or operations in connection with examples of the present disclosure for detecting a mobile data relay device that is a security threat.

In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

FIG. 1 also illustrates mobile data relay devices 160 and 170. In one embodiment, the mobile data relay device 160 may be an unmanned aerial vehicle (UAV) and the mobile data relay device 170 may be a satellite. The UAV may be defined as a device that is flown within the atmosphere of Earth at altitudes e.g., below 18,000 feet. The UAV may be remotely controlled by a pilot or an operator.

In contrast, a satellite may be defined as a mobile data relay device that is flown outside of the atmosphere of Earth and around Earth's orbit. The satellite may be deployed e.g., above 300,000 feet in outer space. The satellite may travel without the control of a pilot or an operator.

In one embodiment, the mobile data relay devices 160 and 170 may be used to transport data across the cellular network 110. For example, some geographic locations may be too remote to build a cell site or RAN. Thus, cellular coverage may be lacking in these remote geographic locations. Thus, the mobile data relay devices 160 and 170 may be deployed to transport data in these remote locations. However, the mobile data relay devices 160 and 170 may also be used to transport data across the cellular network 110 temporarily when a cell site goes down due to malfunction or scheduled maintenance.

The mobile data relay devices 160 and 170 may travel within range of one of the cell sites 121-124 and may be authenticated for communication by the one of the cell sites 121-124 and/or an authentication server 195. Once the mobile data relay device 160 or 170 is authenticated, the mobile data relay device 160 or 170 may transport data from the connected cell site 121-124 to another cell site 121-124, to the UE 104, and/or the other networks 180.

However, as discussed above, one or more of the mobile data relay devices 160 or 170 may be a “rogue” mobile data relay device that is trying to intercept data. The present disclosure provides systems and methods to detect a mobile data relay device that is a security threat, as discussed in further details below.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

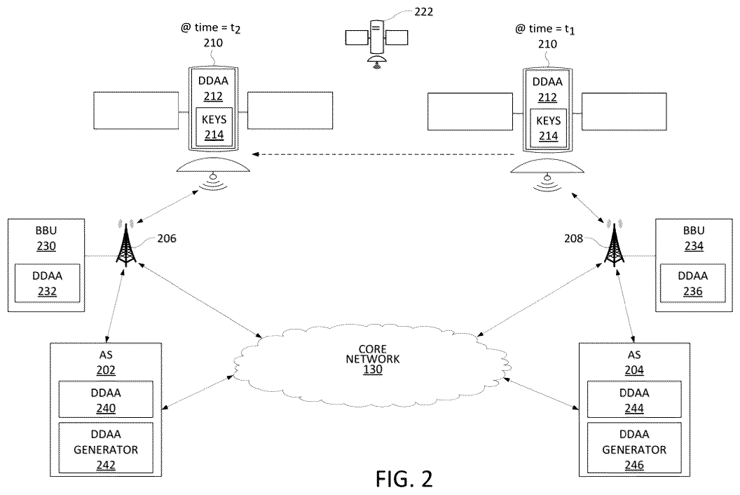

To aid in understanding the present disclosure, FIG. 2 illustrates a block diagram of an example of how a rogue satellite 222 can be detected as a security threat. FIG. 2 illustrates an example where the mobile data relay device 170 comprises a satellite 210. A single satellite 210 is illustrated in FIG. 2 for ease of explanation, however, it should be noted that a plurality of satellites 210 may be deployed that operate similarly to the satellite 210 for authentication.

In addition, the example illustrated in FIG. 2 illustrates an authentication server (AS) 202 and AS 204, cell sites 206 and 208, and the core network 130. Although two AS 202 and AS 204, two cell sites 206 and 208, and a single satellite 210 are illustrated in FIG. 2, it should be noted that any number of authentication servers, cell sites, and satellites may be deployed. In addition, as noted above, a single AS may be deployed rather than a plurality of authentication servers 202 and 204.

In addition, the example illustrated in FIG. 2 is described with the cell sites 206 and 208 authenticating the satellite 210. However, it should be note the satellite 210 may be used to authenticate the cell sites 206 and/or 208. In other words, the methods of authentication described herein may be used to authentication two network devices in either direction.

In one embodiment, the satellite 210 may include a unique authentication application such as a DDAA 212. The DDAA 212 may store one or more keys 214. In one embodiment, each DDAA 212 may be a single instantiation of a plurality of DDAAs that were all created at a particular time, e.g., by an authentication server, where the plurality of DDAAs will be distributed to all relevant network devices, e.g., mobile data relay devices, cell sites, authentication servers, BBUs, etc.

In one embodiment, each one of the network devices that could be used for authentication may also include a copy of a respective DDAA. For example, a BBU 230 of the cell site 206 may include a DDAA 232, a BBU 234 of the cell site 208 may include a DDAA 236, the AS 202 may include a DDAA 240, and the AS 204 may include a DDAA 244.

The DDAAs 212, 232, 236, 240 and 244 may be generated by a DDAA generator 242 of the AS 202 or a DDAA generator 246 of the AS 204. The DDAA generator 242 or the DDA generator 244 may generate the DDAAs 212, 232, 234, 240 and 244 from an overall mathematical model or set of equations. In one embodiment, the mathematical model may represent a three-dimensional shape. For example, the mathematical model (e.g., a set of equations or functions) may represent a sphere, a cube, a cylinder, or any regular or irregular object.

Each of the DDAAs 212, 232, 236, 240 and 244 may represent an equation that represents a unique portion of the three-dimensional shape. Thus, each DDAA 212, 232, 236, 240 and 244 may be validated using the other remaining DDAAs 212, 232, 236, 240 and 244. For example, the combination of DDAAs 212, 232, 236, 240 and 244 should form the overall mathematical model or the set of equations. If the combination of the DDAAs 212, 232, 236, 240 and 244 does not form the overall mathematical model or the set of equations, then it may be determined that one of the DDAAs 212, 232, 236, 240 and 244 is not valid.

As a result, “counterfeit” or “fake” DDAAs cannot be generated by a hacker and added to the cellular network 110. Any new DDAAs that enter the cellular network 110 via the rogue satellite 222 (or any other network devices) would cause the combination of DDAAs 212, 232, 236, 240 and 244 and the “fake” DDAA to fail to result in the expected overall mathematical model or set of equations. For example, if the rogue satellite 222 attempted to enter the network with a “fake” DDAA, the DDAA could easily be identified as being “fake” when validated with the other DDAAs 212, 232, 236, 240 and 244. The combination of the “fake” DDAA of the rogue satellite 222 and the DDAAs 212, 232, 236, 240 and 244 would fail to form the expected overall mathematical model or set of equations. Thus, the DDAAs 212, 232, 236, 240 and 244 may not share key information, location information, and the like, as described below, with the “fake” DDAA.

When a valid new satellite (not shown) is added to the cellular network 110, the DDAA generator 242 or the DDAA generator 246 may delete all of the existing DDAAs 212, 232, 236, 240 and 244, generate newly updated DDAAs for the updated number of network devices (e.g., six DDAAs when a new satellite is added instead of the five illustrated in FIG. 2) based on an updated mathematical model, set of equations, or three-dimensional object, and assign the six (6) updated DDAAs to each of the network devices (e.g., the satellite 210, the BBUs 230 and 234, the ASs 202 and 204, and the new satellite that is added (not shown)). In one embodiment, the DDAAs 212, 232, 236, 240 and 244 may also be encrypted.

In one embodiment, the DDAAs 212, 232, 236, 240 and 244 may be used to exchange information that can be used for authentication. In an embodiment, the information may include location information and a key. In one embodiment, the location information may include predicted location information.

For example, the satellite 210 may be authenticated to a cell site 208 at time t₁. The DDAA 236 may collect information from the DDAA 212 while the satellite 210 is connected to the cell site 208. For example, the information may include behavioral information and location information. The behavioral information may include an amount of time the satellite 210 is connected, an amount of data that is transferred between the satellite 210 and the cell site 208, and the like. The location information may include a last known location of the satellite 210 (e.g., using global positioning satellite (GPS) coordinates), a direction of movement of the satellite 210 (e.g., moving north, northeast, east, southeast, south, southwest, west, or northwest), a current speed or velocity of the satellite 210, an altitude, a current orbital direction, a current orbital path, and the like.

As the satellite 210 continues to move, the satellite 210 may begin to move out of range of the cell site 208 and within range of the cell site 206. To prepare for the hand-off to the cell site 206, the DDAA 236 may transmit location information to the DDAA 232 of the cell site 206 via the core network 130. Based on the location information, the DDAA 232 may generate a dynamic map to visualize how the satellite 210 is moving and predicted locations of the satellite 210 at varying times along the estimated path of the satellite 210.

At time t₂ the satellite 210 moves within range of the cell site 206. The satellite 210 may request authentication with the cell site 206. The satellite 210 may provide current location information to the DDAA 232 along with the authentication request. The DDAA 232 may then compare the current location with the predicted information to determine if there is a match. The match may be within a threshold for each location parameter. For example, if an altitude and GPS location are used, the match may be determined if the altitude of the predicted location and the current location are within an altitude threshold and if the GPS location of the current location and the predicted location are within a GPS location threshold.

Notably, the rogue satellite 222 may not know from which direction, altitude, and speed, the satellite 210 may be travelling from the cell site 208. Thus, if the rogue satellite 222 attempts to connect to the cell site 206, the rogue satellite 222 may not be at the predicted location calculated by the DDAA 232 based on the location information received from the DDAA 236. As a result, the cell site 206 can deny the authentication request from the rogue satellite 222.

Although only two cell sites 206 and 208 are illustrated in FIG. 2, it should be noted that the DDAA 232 may receive location information from hundreds of different DDAAs located at hundreds of different cell sites for hundreds of different satellites. Thus, the amount of location information that may be processed may quickly become overwhelming for processing and memory resources on the BBU 230.

In one embodiment, to prevent overwhelming processor usage and/or memory usage of the BBU 230, the DDAA 232 may calculate a predicted location and generate a map of the satellite 210 using data received within a predefined time period. For example, the DDAA 232 may use data received from the DDAA 236, as well as any other DDAA, from a rolling 12 hour, 24 hour, weekly, and the like, time period. In another example, the time period may be periodic (e.g., every 12 hour, 24 hour, or weekly time increments that are not rolling time periods).

In addition to performing authentication based on the location information, keys can be used in addition to the location information to perform authentication. For example, the satellite 210 may include keys 214.

In one embodiment, the keys 214 may be one-time use keys that are assigned to the satellite 210 from all of the authentication servers 202 and 204. For example, the authentication servers 202 and 204 may share the keys 214 that may be used and then assign the same keys 214 to the satellite 210. In other words, the satellite 210 may receive the same keys 214 from each of the AS 202 and 204. This way, the DDAA 212 of the satellite 210 may know that the keys 214 are valid.

Although the above example illustrates two authentication servers 202 and 204, the above scenario would be the same for many more authentication servers. In other words, if there were ten authentication servers, each of the ten authentication servers may share the keys 214 that may be used. Said another way, each of the ten authentication servers would know the valid keys 214 that will be assigned to the satellite 210. Then, each of the ten authentication servers may transmit the same set of keys 214 to the satellite 210.

In one embodiment, the keys 214 may be one-time use keys. Thus, when the satellite 210 attempts to authenticate with the cell site 208 a first key from the keys 214 may be used. As the satellite 210 moves and attempts to authenticate with the cell site 206, a second key from the keys 214 may be provided to the cell site 206 with the authentication request. The cell site 206 may determine that the key is a valid key by comparing the key to a list of keys that were assigned by the AS 202 or another AS.

After the keys 214 are all consumed, the AS 202 and/or the AS 204 may assign a new set of keys 214 to the satellite 210. In another example, the AS 202 and/or the AS 204 may periodically update the keys 214. For example, the keys 214 may be refreshed or updated each day.

In one embodiment, to further provide improved security, the satellite 210 may be configured as a passive transporter. For example, after the satellite 210 is authenticated with the cell site 206, the cell site 206 may want to transmit data to the cell site 208. The cell site 206 may provide encrypted data to the satellite 210 that includes a destination address of the next node (e.g., another satellite or the cell site 208). The satellite 210 may not have access to decrypt the data or access the content of the encrypted data in any way. The satellite 210 may only have access to the destination address and may simply forward the encrypted data to the next node, such that the encrypted data is eventually transmitted to the destination (e.g., the cell site 208).

As a result, even if a hacker were able to access the satellite 210 the hacker would not have access to the contents of any data transmitted to and from the satellite 210. The satellite 210 would only be deployed as a passive transporter that simply forwards encrypted data to a next node. Thus, the systems and methods of the present disclosure provide improved security for authenticating mobile data relay devices.

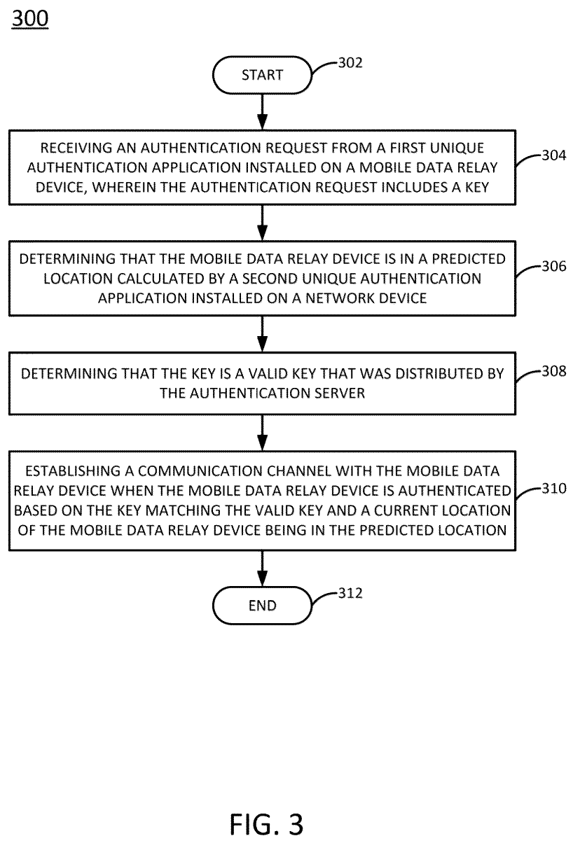

FIG. 3 illustrates a flowchart of an example method 300 for detecting a mobile data relay device that is a security threat, in accordance with the present disclosure. In one example, steps, functions and/or operations of the method 300 may be performed by a device as illustrated in FIG. 1 or FIG. 2, e.g., any of the cell sites 121-124 and/or BBU pool 126 (e.g., including a CU and/or a DU, or the like), cell site 206 and BBU 230, cell site 208 and BBU 234, the AS 195, the AS 202, the AS 204, or any one or more components thereof, such as a processing system, or collectively via a plurality devices in FIG. 1, such as any one or more of AS 195, SMF 137, MME 131, NSSF 136, AMF 135, or cell sites 121-124 in conjunction with another of such components, or one or more other entities, such a network repository function, and so forth. In one example, the steps, functions, or operations of method 300 may be performed by a computing device or system 400, and/or a processing system 402 as described in connection with FIG. 4 below. Similarly, in one example, the steps, functions, or operations of method 300 may be performed by a processing system comprising one or more computing devices collectively configured to perform various steps, functions, and/or operations of the method 300. For instance, multiple instances of the computing device or processing system 400 may collectively function as a processing system. For illustrative purposes, the method 300 is described in greater detail below in connection with an example performed by a processing system, such as processing system 402. The method 300 begins in step 302 and may proceed to step 304.

At step 304, the processing system may receive an authentication request from a first unique authentication application installed on a mobile data relay device, wherein the authentication request includes a key. The “unique” aspect of the authentication application pertains to how the authentication application was instantiated and distributed to the mobile data relay device as discussed above.

For example, the mobile data relay device may be a satellite attempting to be authenticated on a node of a communication network. The node may be an authentication server, cell site, or RAN. The authentication server may be deployed as part of the cell site or as part of the BBU of the cell site or node.

The satellite may have a copy of the first unique authentication application. The first unique authentication application may be a DDAA. The DDAA may be generated by the processing system or an authentication server, as described above. For example, the DDAA may be from an overall mathematical model or set of equations that is related to other DDAAs assigned to other network devices in the communication network. The DDAA may be validated with all other remaining DDAAs in the communication network. For example, all of the DDAAs may be combined to form the overall mathematical model. If any of the DDAAs are missing, any additional DDAAs are detected in the communication network, or any of the DDAAs have been changed, the combination of all of the DDAAs in the communication network may no longer be combined to satisfy or form the overall mathematical model.

Thus, when new network devices are added to the communication network, all existing DDAAs will be deleted, a new mathematical model may be used to generate newly updated DDAAs, and the updated DDAAs may be assigned and distributed to the network devices, including the new network device, in the communication network.

At step 306, the processing system may determine that the mobile data relay device is in a predicted location calculated by a second unique authentication application installed on the network device. Using the above example of a satellite, the satellite may be moving away from a previous cell site and towards a current cell site. The DDAA installed on a network device associated with the previous cell site may transmit location information to the DDAA installed on an authentication server associated with the current cell site. The location information may include at least one of: a last known location of the mobile data relay device, an estimated speed of the mobile data relay device, a direction the mobile data relay device was moving, a path the mobile data relay device was likely to be on, and the like.

Based on the location information, the DDAA of the network device associated with the current cell site may generate a map to visualize the predicted location of the mobile data relay device. In an example, the DDAA may only use location information received in a rolling or fixed predefined time period to generate the map. For example, the network device may use the location information received in the last 12 hours, the last 24 hours, and so forth.

The authentication request from the satellite may include a current location information of the satellite. The current location may be compared to the predicted location. If the current location matches the predicted location, or matches within a threshold, the satellite may be deemed to be in the predicted location.

At step 308, the processing system may determine that the key is a valid key that was distributed by an authentication server. Using the example of the satellite described above, the satellite may be assigned one or more keys by the authentication servers in the communication network. The keys may be one-time use keys that are not reusable. The keys may be periodically refreshed or updated periodically by the authentication servers to ensure that the satellite does not run out of keys.

The authentication request from the satellite may include one of the keys in addition to the current location information. The key provided by the satellite may be compared to a list of known keys distributed by the authentication server and assigned to the satellite. If the key matches one of the keys in the list of known keys, then the key may be determined to be a valid key. If the key is not matched, then the mobile data relay device is deemed to be a security threat and the mobile data relay device is deemed to be a “rogue” mobile data relay device. No services will be provided to the “rogue” mobile data relay device, i.e., step 310 will be skipped as discussed below.

At step 310, the processing system may establish a communication channel with the mobile data relay device when the mobile data relay device is authenticated based on the key matching the valid key and a current location of the mobile data relay device being in the predicted location. For example, if the satellite is in the predicted location (e.g., the satellite is where it should be based on the last known location, direction of movement, speed, and/or path) and the key provided by the satellite is a valid key, then the satellite may be authenticated. A communication channel may be established between the satellite and the cell site.

However, as noted above, to further improve security of the mobile data relay device, the mobile data relay device may be configured to be a passive transporter of data. For example, data transmitted to the mobile data relay device may be encrypted. Only a destination address to a next node or a subsequent network node may be revealed to the mobile data relay device. In other words, the mobile data relay device may have no access to the contents within the encrypted data and may not be able to decrypt the encrypted data. As a result, even if the mobile data relay device is hacked, the hacker may not have access to any of the content within the encrypted data packets. Rather, the mobile data relay device may be used to simply forward packets to the next node.

In one embodiment, as noted above, a new mobile data relay device may be added to the communication network. In response, the authentication server may generate a new first unique authentication application, a new second unique authentication application, and a new third unique authentication application. The new first unique authentication application, the new second unique authentication application, and the new third unique authentication application may represent unique segments of a new mathematical model, as described above.

For example, the first unique authentication application and the second unique authentication application may have been part of a mathematical model that represented a sphere with having a first set of dimensions. The new first unique authentication application, the new second unique authentication application, and the new third unique authentication application may be part of a new mathematical model that represents a cube or a sphere with a second set of dimensions that are different than the first set of dimensions of the previous sphere.

The new unique set of authentication applications may then be assigned by the authentication server. For example, the new first unique authentication application may be assigned to the mobile data relay device, the new second unique authentication application may be assigned to the network device, and the new third unique authentication application may be assigned to the new mobile data relay device. Thus, a rogue satellite cannot simply create a new authentication application or “spoof” the authentication application to try and join the communication network. Rather, to add a new authentication application, all previous authentication applications must be deleted and new copies of the authentication application must be generated as parts of a unique set of a larger mathematical model or set of equations. At step 312, the method 300 ends.

It should be noted that the method 300 may be expanded to include additional steps or may be modified to include additional operations or omit operations with respect to the steps outlined above. For instance, in one example, the method 300 may further include detecting a potential security breach, initiating the generation and distribution of new DDAAs, initiating the generation and distribution of new keys, and the like. Furthermore, in one embodiment if a mobile data relay device cannot be authenticated, then this particular mobile data relay device can be deemed to be a “rogue” mobile data relay device, where a second level of authentication (e.g., a more intensive authentication process) can be triggered to verify the authenticity of the mobile data relay device. If the authenticity of the mobile data relay device cannot be verified, then this “rogue” mobile data relay device can be blacklisted and/or tracked in a database to ensure that it cannot be authenticated in the future. In one example, the method 300 may be expanded or modified to include steps, functions, and/or operations, or other features described in connection with the example(s) of FIGS. 1, 2, and/or 4, or as described elsewhere herein. Thus, these and other modifications are all contemplated within the scope of the present disclosure.

In addition, although not specifically specified, one or more steps, functions, or operations of the example method 300 may include a storing, displaying, and/or outputting step as required for a particular application. In other words, any data, records, fields, and/or intermediate results discussed in the method(s) can be stored, displayed, and/or outputted either on the device executing the method or to another device, as required for a particular application. Furthermore, steps, blocks, functions or operations in FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 4 depicts a high-level block diagram of a computing device or processing system specifically programmed to perform the functions described herein. For example, any one or more components or devices illustrated in FIG. 1, or described in connection with the examples of FIGS. 2 and 3, respectively, may be implemented as the processing system 400. As depicted in FIG. 4, the processing system 400 comprises one or more hardware processor elements 402 (e.g., a microprocessor, a central processing unit (CPU) and the like), a memory 404, (e.g., random access memory (RAM), read only memory (ROM), a disk drive, an optical drive, a magnetic drive, and/or a Universal Serial Bus (USB) drive), a module 405 for detecting a mobile data relay device that is a security threat, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like). In accordance with the present disclosure input/output devices 406 may also include antenna elements, antenna arrays, remote radio heads (RRHs), baseband units (BBUs), transceivers, power units, and so forth.

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for detecting a mobile data relay device that is a security threat (e.g., a software program comprising computer-executable instructions) can be loaded into memory 404 and executed by hardware processor element 402 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for detecting a mobile data relay device that is a security threat (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
receiving, by a processor of a network device, an authentication request from a first authentication application installed on a mobile data relay device, wherein the authentication request includes a key;
determining, by the processor, that the mobile data relay device is in a predicted location calculated by a second authentication application installed on the network device;
determining, by the processor, that the key is a valid key that was distributed by a first authentication server; and
establishing, by the processor, a communication channel with the mobile data relay device when the mobile data relay device is authenticated based on the key being determined to be the valid key and a current location of the mobile data relay device being in the predicted location.

2. The method of claim 1, further comprising:
transmitting, by the processor, a data packet to the mobile data relay device, wherein the data packet only reveals a destination address to the mobile data relay device to forward the data packet to a subsequent network node.

3. The method of claim 1, wherein the mobile data relay device comprises a satellite.

4. The method of claim 1, wherein the mobile data relay device comprises an unmanned aerial vehicle.

5. The method of claim 1, wherein the first authentication application and the second authentication application represent segments of a mathematical model.

6. The method of claim 1, further comprising:
detecting, by the processor, that a new mobile data relay device is added to a communication network; and
receiving, by the processor, a new second authentication application, wherein the new second authentication application is assigned by the first authentication server that generated a new first authentication application, the new second authentication application, and a new third authentication application, wherein the new first authentication application, the new second authentication application, and the new third authentication application represent segments of a new mathematical model, and wherein the new first authentication application is assigned to the mobile data relay device and the new third authentication application is assigned to the new mobile data relay device.

7. The method of claim 1, wherein the key is assigned to the mobile data relay device by each one of a plurality of authentication servers, wherein the plurality of authentication servers comprises the first authentication server.

8. The method of claim 1, wherein the key is one of a plurality of keys assigned to the mobile data relay device.

9. The method of claim 8, wherein the plurality of keys assigned to the mobile data relay device is updated periodically.

10. The method of claim 1, wherein the key is a one-time use key.

11. The method of claim 1, wherein the predicted location is calculated based on location information received from a third authentication application installed on a second network device that was in communication with the mobile data relay device.

12. The method of claim 11, wherein the location information comprises at least one of: a last known location of the mobile data relay device, an estimated speed of the mobile data relay device, a direction that the mobile data relay device was moving, or a path that the mobile data relay device is traveling on.

13. The method of claim 12, wherein the second authentication application generates a map based on the location information to visualize the predicted location of the mobile data relay device.

14. The method of claim 13, wherein the second authentication application only uses the location information received in a rolling predefined time period to generate the map.

15. A non-transitory computer-readable medium storing instructions which, when executed by a processor of a network device, cause the processor to perform operations, the operations comprising:
receiving an authentication request from a first authentication application installed on a mobile data relay device, wherein the authentication request includes a key;
determining that the mobile data relay device is in a predicted location calculated by a second authentication application installed on the network device;
determining that the key is a valid key that was distributed by a first authentication server; and
establishing a communication channel with the mobile data relay device when the mobile data relay device is authenticated based on the key being determined to be the valid key and a current location of the mobile data relay device being in the predicted location.

16. The non-transitory computer-readable medium of claim 15, the operations further comprising:
transmitting a data packet to the mobile data relay device, wherein the data packet only reveals a destination address to the mobile data relay device to forward the data packet to a subsequent network node.

17. The non-transitory computer-readable medium of claim 15, wherein the mobile data relay device comprises a satellite.

18. The non-transitory computer-readable medium of claim 15, wherein the first authentication application and the second authentication application represent segments of a mathematical model.

19. The non-transitory computer-readable medium of claim 15, the operations further comprising:
detecting that a new mobile data relay device is added to a communication network; and
receiving a new second authentication application, wherein the new second authentication application is assigned by the first authentication server that generated a new first authentication application, the new second authentication application, and a new third authentication application, wherein the new first authentication application, the new second authentication application, and the new third authentication application represent segments of a new mathematical model, and wherein the new first authentication application is assigned to the mobile data relay device and the new third authentication application is assigned to the new mobile data relay device.

20. An apparatus comprising:
a processing system including at least one processor; and
a non-transitory computer-readable medium storing instructions which, when executed by the processing system when deployed in a cellular network, cause the processing system to perform operations, the operations comprising:
receiving an authentication request from a first authentication application installed on a mobile data relay device, wherein the authentication request includes a key;
determining that the mobile data relay device is in a predicted location calculated by a second authentication application installed on the network device;
determining that the key is a valid key that was distributed by a first authentication server; and
establishing a communication channel with the mobile data relay device when the mobile data relay device is authenticated based on the key being determined to be the valid key and a current location of the mobile data relay device being in the predicted location.
